(19) United States
(12) Patent Application Publication
(10) Pub. No.: US 2016/0041564 A1
(43) Pub. Date: Feb. 11, 2016

(54) REVERSE FLOW MODE FOR REGULATING PRESSURE OF AN ACCUMULATED VOLUME WITH FAST UPSTREAM BLEED DOWN

(71) Applicants: Daniel T. MUDD, Reno, NV (US); Patti J MUDD, Reno, NV (US)

(72) Inventors: Daniel T. MUDD, Reno, NV (US); Patti J MUDD, Reno, NV (US)

(21) Appl. No.: 14/887,334

(22) Filed: Oct. 20, 2015

Related U.S. Application Data
(63) Continuation-in-part of application No. 14/700,125, filed on Apr. 29, 2015.
(60) Provisional application No. 61/996,146, filed on Apr. 29, 2014.

(51) Int. Cl. G05D 7/06; G05B 15/02

(52) U.S. Cl. CPC G05D 7/06; G05B 15/02

(57) ABSTRACT

A reverse flow mode depressurizes process gas from an accumulated volume in an MFC or other gas delivery apparatus for faster pressure bleed down when transitioning to lower internal pressures. For example, a semiconductor process receiving nitrogen gas at a certain mass flow rate can require a reduction of apparatus internal pressure in order to quickly reduce the mass flow rate. During the reverse flow mode, a gas supply valve is closed and an upstream purge valve is opened to reduce pressure upstream of a proportional valve. Also, the proportional valve is further opened for decreasing target pressure quickly.

### CROSS-REFERENCE TO RELATED APPLICATIONS

This application claims the benefit of priority under 35 U.S.C. 120 as a continuation-in-part to U.S. application Ser. No. 14/700,125, filed Apr. 29, 2015, entitled PRESSURE-BASED MASS FLOW CONTROLLER WITH REVERSE FLOW MODE FOR FAST BLEED DOWN, which in turn claims priority under 35 U.S.C. 119(e) to U.S. Application No. 61/996,146, filed Apr. 29, 2014, entitled DEVICES, MECHANISMS AND ALGORITHMS TO ADDRESS THE SLOW BLEED DOWN RESPONSE ISSUE SEEN IN PRESSURE BASED FLOW CONTROL DEVICES, by Daniel T. Mudd et al., the contents of both being hereby incorporated by reference in their entirety. This application is also related to U.S. application Ser. No. 13/590,152, filed Aug. 20, 2012, entitled FLOW NODE TO DELIVER PROCESS GAS USING A REMOTE PRESSURE MEASUREMENT DEVICE, by Daniel T. Mudd et al., the contents of which is hereby incorporated by reference in its entirety.

### FIELD OF THE INVENTION

The invention relates generally to gas delivery in semiconductor processing, and more specifically, using a reverse flow mode for regulating pressure of an accumulated volume for fast pressure reduction in a volume.

### BACKGROUND

Mass flow controllers (MFCs) and electronic regulators are important components for delivering process gasses (e.g., N2, O2, SF6, and C4F) for semiconductor fabrication. MFCs are normally used to turn on, turn off, and control process gas flows at a desired flow rate. The MFC typically functions as a subsystem within a larger capital equipment apparatus referred to as a tool.

However, commercially available pressure based MFCs are slow to transition between gases or to transition from higher to lower flow rates of a single gas, particularly for lower full scale flow rated devices, because of space within conduits of MFCs that are depressurized during transitions (also known as an accumulation volume). Typical response times can be between 0.2 and 4.0 seconds. Response times longer than 4.0 seconds are typically not allowed on many applications as monitoring systems on some equipment alarm at 4 seconds. The smaller the device's full scale rating the slower the depressurization response time. The 4 second limit currently excludes devices with full scale flow rating 100 SCCM (standard cubic centimeter per minute) or below. This slow response either creates a bottleneck in semiconductor processing, particularly for ALD and 3D-IC processing and/or forces poorer accuracies on flow rates below 50 SCCM as larger full scale devices are used to avoid unacceptable response times. Conventional techniques such as natural bleed off are slower than desired. Additionally, downstream purging or diverting techniques can require undesirable hardware modifications or additions.

Of particular interest are the accumulation volumes in pressure based MFCs and flow measurement systems that delivery process gas at low flow rates. With smaller mass flows, the depressurization process of the accumulated volumes can slow down the transition of the MFC to an intolerable amount of time.

Therefore, what is needed is a robust technique in gas delivery apparatus to overcome the shortcomings of the prior art by evacuating process gas in an accumulation volume upstream of a characterized flow resistance to a non-process location.

### SUMMARY

The present invention addresses these shortcomings by providing gas delivery apparatus, gas delivery methods, and non-transitory computer readable media for reversing gas mass flow from an accumulation volume for faster pressure bleed down when going to the lower pressures required for lower mass flows. For example, a semiconductor process receiving oxygen gas at a certain mass flow rate can benefit from a reduction in a target pressure in order to quickly reduce the mass flow rate.

In one embodiment, a gas delivery apparatus comprises an MFC (mass flow controller), a flow node and associated electronic regulator, sensors and control system, or any related device that depressurizes (bleeds down) an accumulation volume by switching from a default forward flow mode, from a gas supply, to a reverse flow mode out of the accumulated volume. More specifically, an electronic regulator of the apparatus can open and close its proportional valve in accordance with control coefficients in a PID controlled manner or it can open and close its proportional valve in a more basic, fully open or fully closed “On/Off” or “Bang/Bang” manner. Variable restriction from the proportional valve controls a pressure of an accumulation volume located downstream from the gas supply. The most rapid depressurization will occur if, assuming actions are taken to reduce the pressure in front of the valve, when the proportional valve opens fully immediately when commanded, i.e. “bang open”. However, this technique can introduce variability in the depressurization timing and final pressure value. If more control of the depressurization timing and final pressure is desired for the accumulation volume, PID control of the proportional valve can be used in conjunction with feedback from the existing pressure transducer and other algorithms known in the art. In one embodiment, during a forward flow mode, a proportional valve is further opened for increasing target pressure when an upstream pressure is greater than a downstream pressure of the accumulated volume. By contrast, during the reverse flow mode, the proportional valve is further opened for decreasing target pressure when the upstream pressure is less than the downstream pressure of the accumulated volume.

In some embodiments, a purge valve and a gas supply valve are located upstream of the proportional valve being adjusted. Initially, in the forward flow mode, the gas supply valve is open and the purge valve is closed to build up pressure on the proportional valve. Pressure is decreased on the proportional valve when switching to the reverse flow mode by closing the gas supply valve and opening the purge valve. As a result, the pressure drop in combination with further opening the proportional valve, quickly evacuates process gas from the accumulated volume through the purge valve while in the reverse flow mode.

One implementation utilizes a characterized restrictor disposed downstream of the proportional valve and the accumulated volume to generate a specific mass flow rate based on a pressure of the accumulated volume. In one example, depressurization reduces a first mass flow rate to a second mass flow rate for the same process gas.

Advantageously, semiconductor processing efficiency is improved through (1) faster transition response times for process gas delivery, particularly at low flow rates and (2) more accurate flow control at lower flow rates. Additionally, lower flow rates than currently used become practical as smaller full scale devices can be built with lower conductance restrictors because the bleed down time limitation of 4 seconds, or similar, can readily be met for all restrictors given this reverse flow operation as described.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a perspective diagram illustrating a gas delivery apparatus utilizing a reverse flow mode for fast bleed down of an accumulated volume, according to one embodiment.

FIG. 2A-2B is a more detailed block diagram illustrating a view of an electronic regulator of a gas delivery apparatus, according to an embodiment.

FIGS. 3A-3B are block diagrams illustrating more abstract views of components involved in a forward flow mode and in a reverse flow mode, according to an embodiment.

FIG. 4 is a flowchart diagram illustrating a method for utilizing a reverse flow mode for fast bleed down of an accumulated volume, according to an embodiment.

FIG. 5 is a more detailed flowchart diagram illustrating a step of transitioning from a forward flow mode to a reverse flow mode, according to an embodiment.

FIG. 6 is a perspective diagram illustrating a gas delivery apparatus utilizing a reverse flow mode for fast bleed down of an accumulated volume, according to an embodiment.

FIG. 7 is a perspective diagram illustrating a gas delivery apparatus utilizing a reverse flow mode for fast bleed down of an accumulated volume, according to an embodiment.

### DETAILED DESCRIPTION

Gas delivery apparatus, gas delivery methods, non-transitory computer-readable media with source code, for reversing gas flow from an accumulation volume for pressure regulation with fast pressure bleed down, are disclosed. One of ordinary skill in the art will recognize, given the below description, variations available to one of ordinary skill in the art, such as the application of these principles to fluid, or a mix of gasses and fluid, in an accumulation volume.

Fine chemical synthesis, pharmaceutical production, optical fiber processing, nano material manufacturing, and similar high purity fluid delivery applications will also benefit from the disclosed techniques. General industrial applications can also benefit where a single device can act as both a standard forward pressure regulator and a back pressure regulator thereby replacing the need for extra hardware and providing a cost reduction.

### I. GAS DELIVERY APPARATUS USING BOTH FORWARD AND REVERSE FLOW MODE FOR PRESSURE REGULATION OF AN ACCUMULATION VOLUME

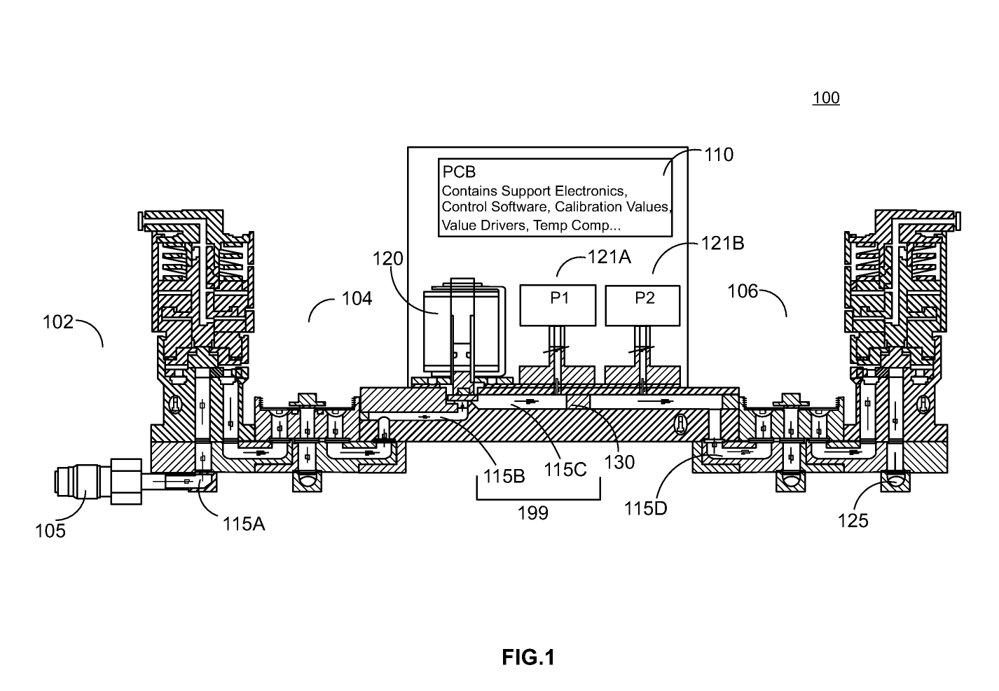

FIG. 1 is a perspective diagram illustrating a gas delivery apparatus 100 utilizing a reverse flow mode for fast bleed down of an accumulation volume 199, according to one embodiment. The gas delivery apparatus 100 can be, for example, an MFC (mass flow controller), a flow node and associated hardware, or the like. In one example, a low flow MFC delivers oxygen or nitrogen to a semiconductor fabrication process in a clean room. A flow path of the gas delivery apparatus 100 includes a conduit inlet 105 receiving downstream to conduits 115A-D, accordingly, and exhausting downstream to a process at a conduit outlet 125. A preferred embodiment of the gas delivery apparatus 100 involves low flow gas delivery which can be characterized as less than 100 SCCM (standard cubic centimeters per minute) or approximately 4/1000 chemical mole per minute. Although gas is referred to throughout the description for simplicity, some embodiments handle liquid or a dynamic mixture of gas and liquid (e.g., droplets). Some embodiments comprise more than one characterized restrictor for wider dynamic accuracy (e.g., in a parallel configuration).

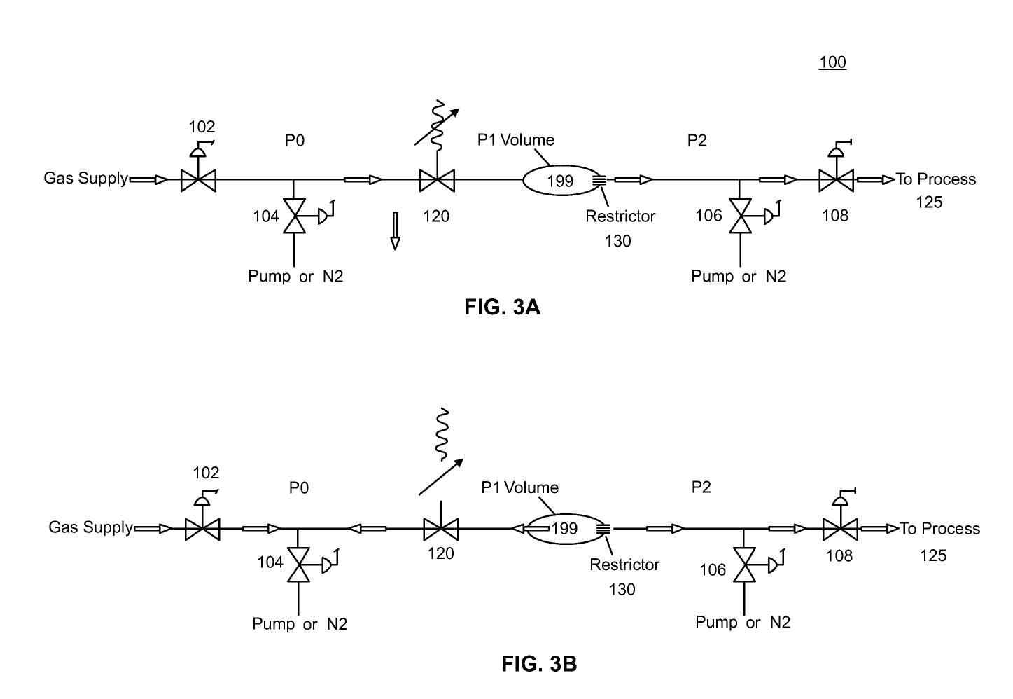

An accumulated (accumulation) volume includes at least a portion of space within the conduit 115C between a proportional valve 120 and a characterized restrictor 130. A pressure transducer 121A measures an associated pressure (i.e., pressure P1 in volume V1). Some embodiments also include space within the conduit 115B upstream of the proportional valve 120. Spacing within and between components can also be included. FIGS. 3A and 3B show an abstraction of the gas delivery apparatus 100 including the accumulated volume 199 (P1 volume). However, space within the upstream conduit 115A and the downstream conduit 115D can be effectively separated from the accumulated volume 199 and considered as a second accumulated volume and have a different pressure as measured by a second pressure transducer 121B (i.e., volume V2 held at pressure P2). A second downstream cycle purge valve 106 can be used to regulate pressure within the second accumulated volume of conduit 115D. In some cases, the second accumulated volume does affect pressurization of the first accumulated volume 199. The conduits 115A-D can be any suitable tubing or plumbing, either rigid or flexible, to deliver gas (or fluid) to the next stage. The conduits 115A-D can have a diameter of, for example, ¼ inch.

An electronic regulator (or electronic pressure regulator) 110 communicatively couples to a valve system and the proportional valve 120. Based on inputs of set points and sensor feedback (e.g., from pressure transducer 121A), commands are sent from the electronic regulator 110 to the valve system to open or close valves. Also commands can be sent to the proportional valve 120 which can further open, further close, or stop adjustments. When sensor feedback indicates that the accumulated volume pressure is too low, a forward flow mode is implemented to intake a mass of the process gas with a downstream flow (e.g., by opening the proportional valve 120). When sensor feedback indicates that the accumulated volume pressure is near a target range, a halt or rate reduction is implemented (e.g., by stopping or slowing down adjustments of the proportional valve 120). Finally, when sensor feedback indicates that the accumulated volume pressure is too high, some embodiments implement a reverse flow mode to evacuate a mass of the process gas (e.g., by closing the gas supply shut-off valve 102, opening the upstream cycle purge valve 104, and controlling the proportional valve 120). In some embodiments, a control system of the electronic regulator 110 may function in the forward flow mode as a standard pressure reducing regulator and may function in the reverse flow mode as a back pressure regulator. In both instances the electronic regulator 110 will actively adjust and control the pressure in the accumulated volume 199 according to inputs of set points and sensor feedback.

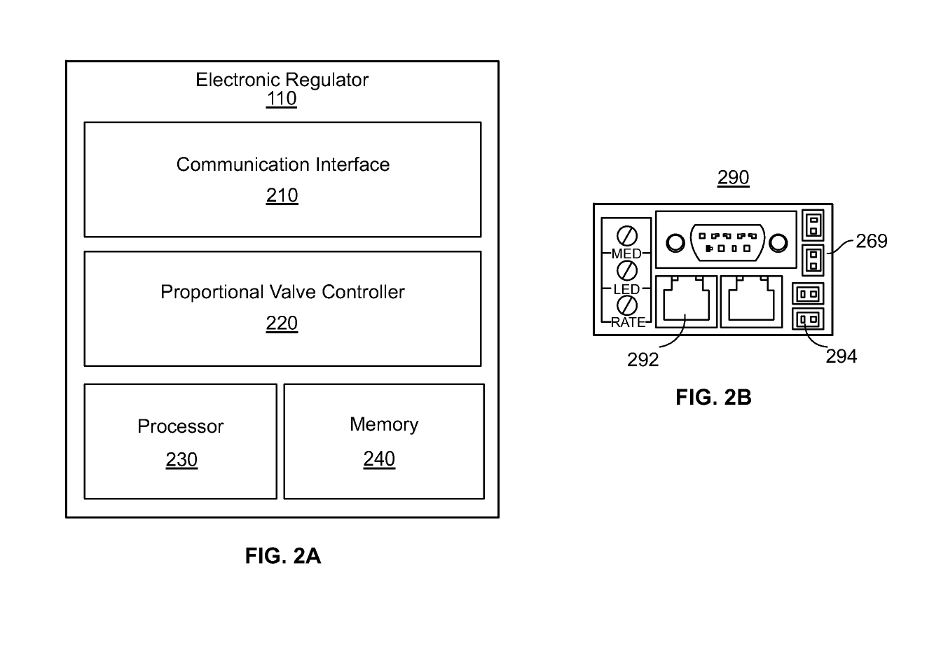

The electronic regulator 110 can switch modes periodically or in near real-time responsive to changing inputs. In some implementations, the electronic regulator 110 may switch control strategy responsive to more inputs than just pressure. For example, a flow command below a threshold can require a relatively large accumulation volume pressure drop, or a pressure drop in a short amount of time (i.e., short bleed down time), accomplished by resorting to the reverse flow mode. In such a situation the electronic regulator 110 may close the gas supply shut-off valve 102, open the upstream cycle purge valve 104, and set the proportional valve 120 to a fully open condition (not subject to customary PID control) to quickly achieve a desired large pressure drop. Another example involves switching from one type of gas to another in which the entire accumulated volume is bled. Still another embodiment factors in temperature feedback from sensors for additional control functions. A more detailed view of the electronic regulator 110 is set forth below with respect to FIG. 2.

The valve system of FIGS. 1, 3A and 3B may be controlled by a controller of the electronic regulator 110 to implement the forward and reverse flow modes, as shown in FIGS. 3A and 3B. In the forward flow mode of FIG. 3A, a gas supply valve 102 can be opened and a purge valve 104 closed. This arrangement allows pressure to build up behind the proportional valve 120 upstream for pressurizing the accumulation volume 199 as the proportional valve 120 is further opened. However, in the reverse flow mode of FIG. 3B, the gas supply valve 102 can be closed and the purge (or dump) valve 104 opened. This depressurizes space in the conduit 115B held behind the proportional valve 120 notionally upstream of the accumulated volume. As the proportional valve 120 further opens, reverse flow from the accumulated volume transits into the open purge valve 104 which evacuates gas to a non-process location using a vacuum pump. Additional valves are possible (e.g., outlet valve 108). Alternatively, the semiconductor capital equipment tool (not shown), within which the gas delivery apparatus 100 is installed, may control the configuration of the supply valve 102 and the purge valve 104 while adjusting set point commands to the electronic regulator 110 and thereby directing suitable control of the proportional valve 120 to implement the forward and reverse flow modes.

The proportional valve 120, responsive to the electronic regulator 110, may function as the primary adjustable control element in both the forward and reverse flow modes. To enable control of flow in both the forward and reverse flow modes the proportional valve 120 is located within a conduit upstream of the accumulated volume 199 and downstream from both the gas supply line valve 102 that supplies the process gas and the purge line valve 104 that evacuates process gas.

A characterized restrictor 130 impedes (or resists) the process gas from exhausting in accordance with component sizing. Specific impedance characteristics are designed by sizing components therein. In one embodiment, the accumulated volume exists in a space downstream of the proportional valve 120 and upstream of the characterized restrictor 130. In other words, the characterized restrictor 130 can effectively separate the accumulated volume from an exhaust pathway. Another embodiment includes the space upstream of the proportional valve 120. Generally, various aggregates of conduit space and/or spacing within components can contribute to the accumulated volume. As the accumulation volume pressurizes or depressurizes, a resulting mass flow rate increases and decreases. In an embodiment, the characterized restrictor 130 further comprises a valve seat and poppet or other valve and seat mechanisms known in the art.

FIG. 2 is a block diagram illustrating a view of an electronic regulator of a gas delivery apparatus, according to an embodiment. The electronic regulator 110 comprises a communication interface 210, a proportional valve controller 220, a processor 230 and a memory 240.

The communication interface 210 receives data used for determination of forward and reverse flow modes, and sends data for adjustment of the proportional valve 120. The received data can include external set points that define a desired mass flow rate for delivery of the process gas to the semiconductor process. Additional received data can be pressure sensor and/or temperature sensor feedbacks. Other embodiments of the communication interface 210 involve sending and receiving data that is only peripherally related to determination of forward and reverse flow modes, as well as unrelated data.

The communication interface 210 comprises hardware and/or software. Hardware can be male or female connections for inputs and/or outputs, such as a serial port, a parallel port, a USB port, a FireWire port, an IEEE 802.11 Wi-Fi radio, an Ethernet port, a Bluetooth radio, a radio jack, radios, or any other appropriate port capable of electrical or electro-magnetic signaling. The software can include network communication modules, operation systems, applications, daemons, coders, decoders, memory, source code, and any other appropriate aspects of communication, stored on a non-tangible computer readable media

For example, detail 290 illustrates a schematic of various ports used for communication in an embodiment. An R45 jack 292 provides an Ethernet receptacle for connecting to an enterprise network for remotely sending external set points from a controller computer. A signaling port 294 connects to a proportional valve for sending control signals for further opening, further closing, and stop, for instance. Another signaling port 296 receives pressure and/or temperature sensor feedback. Other ports are available for other types of connections, such as a direct connection from an administrator.

The proportional valve controller 220, responsive to the external set points, may determine whether to operate in a forward mode or a reverse mode for meeting a target pressure in an accumulated volume, and perform algorithms for PID valve control and flow calculations based in part upon existing sensed conditions. In forward mode the process gas flows in a usual downstream direction through an electronic regulator into an accumulated volume. In reverse mode the process gas flows in an unusual locally upstream direction through the electronic regulator out of the accumulated volume.

The processor 230 can be, without limitation, a microprocessor, a customized ASIC, or any appropriate mechanism for executing source code, in accordance with embodiments described herein. For example, the processor 230 can detect when a threshold has been exceeded leading to the reverse flow mode. Also, the processor 230 can map specific commands from external set points.

The memory 240 can be, without limitation, RAM, ROM, cache, virtualized memory, queues, instruction stacks, flash memory, or any appropriate hardware and/or software for storing source code, values, and the like, in accordance with embodiments described herein.

### II. METHODS FOR USING REVERSE FLOW MODE FOR PRESSURE REGULATION OF AN ACCUMULATED VOLUME

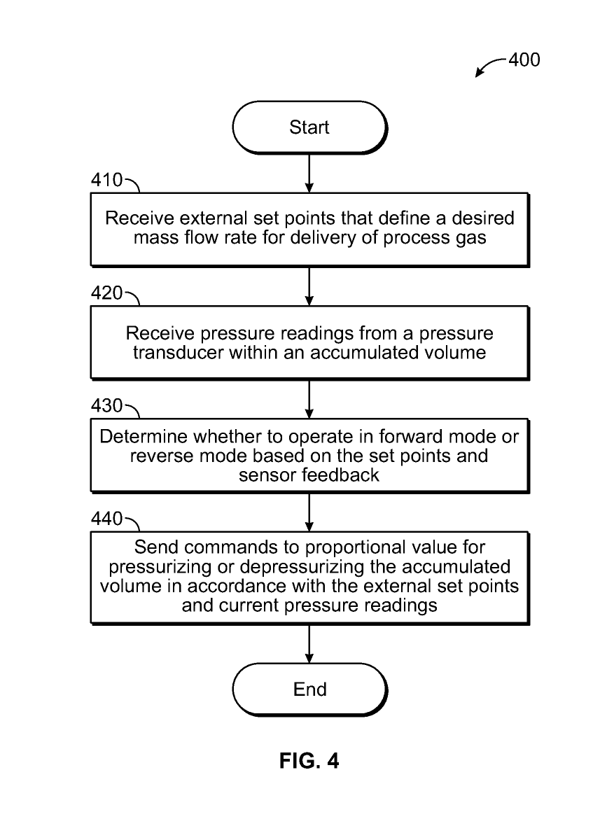

FIG. 4 is a flowchart diagram illustrating a method 400 for utilizing a reverse flow mode for fast bleed down of an accumulated volume, according to an embodiment of the present invention. In one case, the method 400 is implemented in the electronic regulator 110 of the system 100 of FIG. 1, and in other cases, is implemented in alternative systems. Further, the order of steps can be interchanged, and there can be more or less steps than shown in implementations.

External set points that define a desired mass flow rate for delivery of process gas are received (step 410). Pressure readings are received from a pressure transducer within an accumulated volume (e.g., periodically or on demand) (step 420). Other sensor feedback can include temperature readings. Next, it is determined whether to operate a proportional valve in forward mode or reverse mode based on the set points and sensor feedback (step 430). In turn, commands are sent to the proportional valve for pressurizing or depressurizing the accumulated volume in accordance with the set points and current pressure readings (step 440).

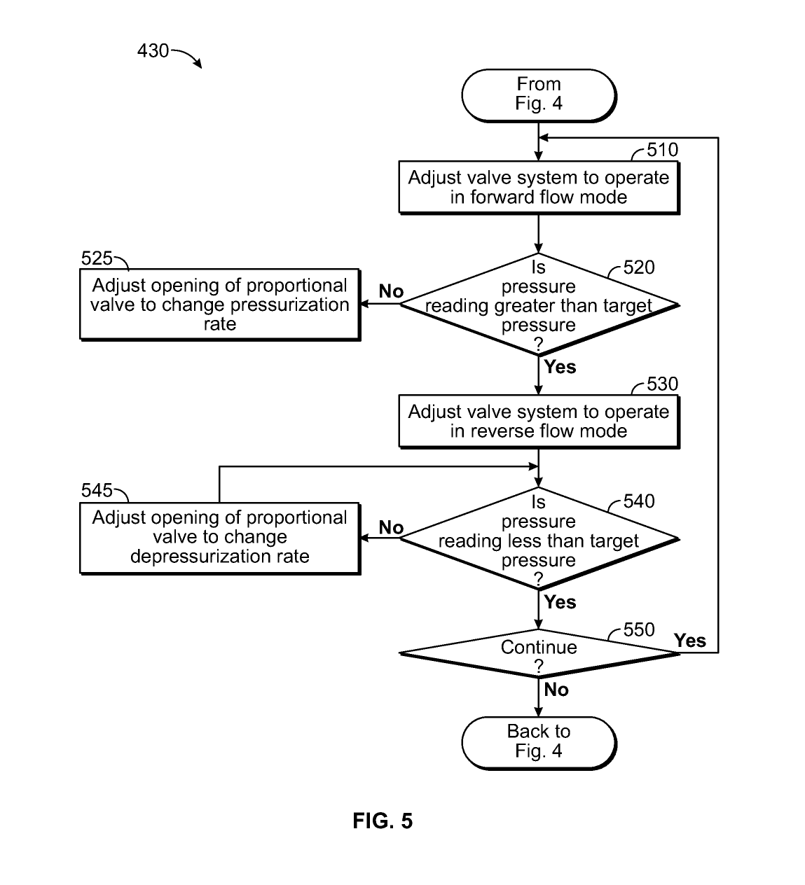

FIG. 5 is a more detailed flowchart diagram illustrating a step 430 of transitioning from a forward flow mode to a reverse flow mode, according to an embodiment of the present invention. The step 430 can be implemented, without limitation, in the proportional valve controller 220 of the electronic regulator 110 of FIG. 2.

A valve system initially operates in forward flow mode (step 510). Based on pressure readings received from a pressure transducer, it is determined whether the pressure reading is greater than a target pressure (step 520). If the pressure is greater, the valve system is adjusted to operate in reverse flow mode (step 530). If the pressure is not greater, an opening of the proportional valve can optionally be adjusted as needed (e.g., further opened, further closed, or halted) (step 525).

If the pressure reading is less than the target pressure while operating in a reverse flow mode (step 540), and the process continues (step 550), the valve system is adjusted to operate in the forward flow mode (step 510). On the other hand, if the pressure is not less than the target pressure, the proportional valve opening can be optionally adjusted to change the depressurization rate (step 545).

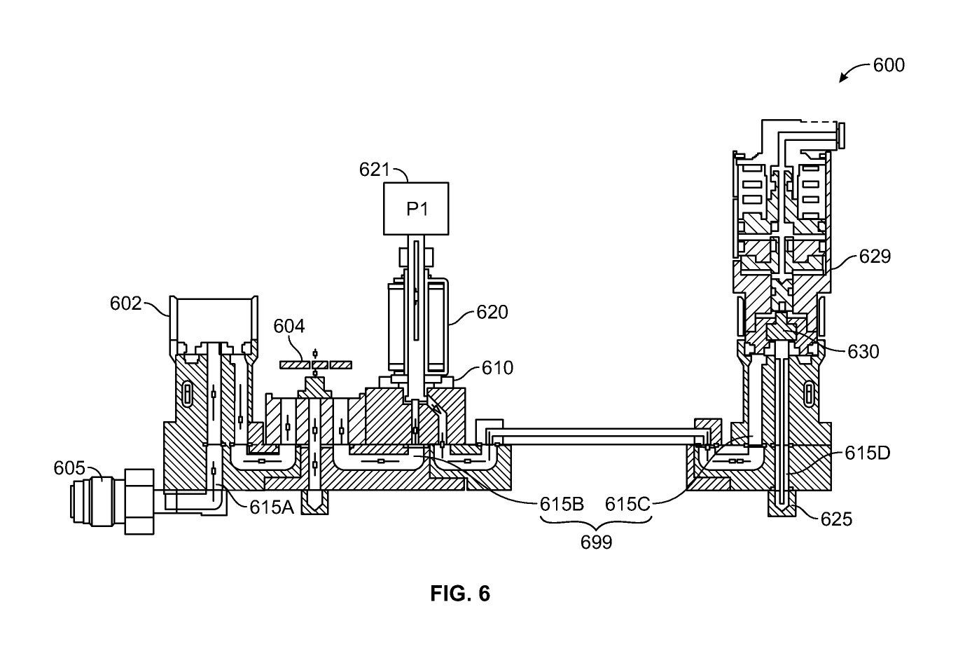

FIG. 6 is a perspective diagram illustrating a gas delivery apparatus 600 utilizing a reverse flow mode for fast bleed down of an accumulation volume 699, according to another alternative embodiment. The gas delivery apparatus 600 may be used to provide controlled delivery of a reactant to a semiconductor manufacturing process, for example. The illustrated alternative gas delivery apparatus 600 includes a gas supply shut-off valve 602, an upstream cycle purge valve 604, an electronic pressure regulator 610, and a flow node 629. A flow path of the alternative gas delivery apparatus 600 includes a conduit inlet 605 receiving downstream to conduits 615A-D, accordingly, and exhausting downstream to a process at a conduit outlet 625. A preferred embodiment of the gas delivery apparatus 600 involves low flow gas delivery which can be characterized as less than 100 SCCM (standard cubic centimeters per minute) or approximately 4/1000 chemical mole per minute. Some alternative embodiments comprise more than one flow node for wider dynamic accuracy (e.g., in a parallel configuration).

An accumulated (accumulation) volume 699 includes at least a portion of space within the conduit 615B between the gas supply shut-off valve 602 and the electronic pressure regulator 610 combined with at least a portion of space within the conduit 615C between the electronic pressure regulator 610 and a flow node 629. The electronic pressure regulator 610 includes a pressure transducer 621 which measures an associated pressure and also a proportional valve 620. Spacing within and between components may also be included in consideration of the accumulated volume 699. The flow node 629 includes a characterized restrictor 630 in series and directly adjacent with a valve seat and diaphragm which together may function as a downstream outlet shut-off valve. The illustrated gas delivery apparatus 600 has a form factor comprising decentralized components making up a gas stick using a flow node and associated electronic regulator, sensors and control system, as opposed to the conventional gas stick of FIG. 1. The alternative gas delivery apparatus 600 illustrates use of metallic tubing and machined surface mount fluid delivery substrates as known in the semiconductor capital equipment industry.

A process control system (not shown) may use the gas delivery apparatus 600 in a forward flow mode in the following manner. Process gas enters through the inlet conduit 605 and passes through the gas supply valve 602 into the conduit 615B upstream of the electronic pressure regulator 610 while the upstream cycle purge valve 604 is in a closed condition. A target pressure set point is provided by the process control system to the electronic pressure regulator 610 based at least in part upon a desired mass flow rate to be provided to the process by the flow node 629. The electronic pressure regulator 610 includes the pressure transducer 621 which measures a pressure within the conduit 615C upstream of the flow node 629, and adjusts the proportional valve 620 to keep the measured pressure approximately equal to the target pressure (opening the proportional valve 620 more if the measured pressure is too low or reducing the opening of the proportional valve 620 if the pressure is too high, as is known with forward pressure regulator control systems). Process gas flows from the conduit 615C upstream of the flow node 629, into the flow node 629, and through the characterized restrictor 630 and exhausting downstream to a process at a conduit outlet 625.

The process control system (not shown) may in the following manner use the gas delivery apparatus 600 in a reverse flow mode in response to inputs. Changing to reverse flow mode may be done when needing a fast reduction of gas delivery flow rate, for example. The gas supply valve 602 is placed into a closed condition and the upstream cycle purge valve 604 is placed into an open condition thereby connecting the conduit 615B upstream of the electronic pressure regulator 610 to a vacuum suction (sink) thereby reversing the flow supplied to the electronic pressure regulator 610 and rapidly reducing the supplied process gas pressure. Strategies for removing process gas from the conduit 615C between the electronic pressure regulator 610 and the flow node 629 may depend upon design of the electronic pressure regulator 610. For example, temporarily providing a large target pressure set point to the electronic regulator 610 will cause a forward pressure regulator control system to further open the proportional valve 620 thereby allowing process gas to reverse flow leaving the conduit 615C and pass into the vacuum suction (sink) through the cycle purge valve 604. Alternatively, the electronic pressure regulator 610 may be reconfigurable to operate in a back pressure regulation mode. In such instance the process control system may provide a new reduced target pressure set point to the reconfigured pressure regulator 610 whereby the pressure transducer 621, which measures a pressure within the conduit 615C upstream of the flow node 629, provides local feedback and the reconfigured electronic pressure regulator 610 adjusts the proportional valve 620 to keep the measured pressure approximately equal to the target pressure (reducing the opening of the proportional valve 620 if the measured pressure is too low or increasing the opening of the proportional valve 620 if the pressure is too high, as is known with back pressure regulator control systems).

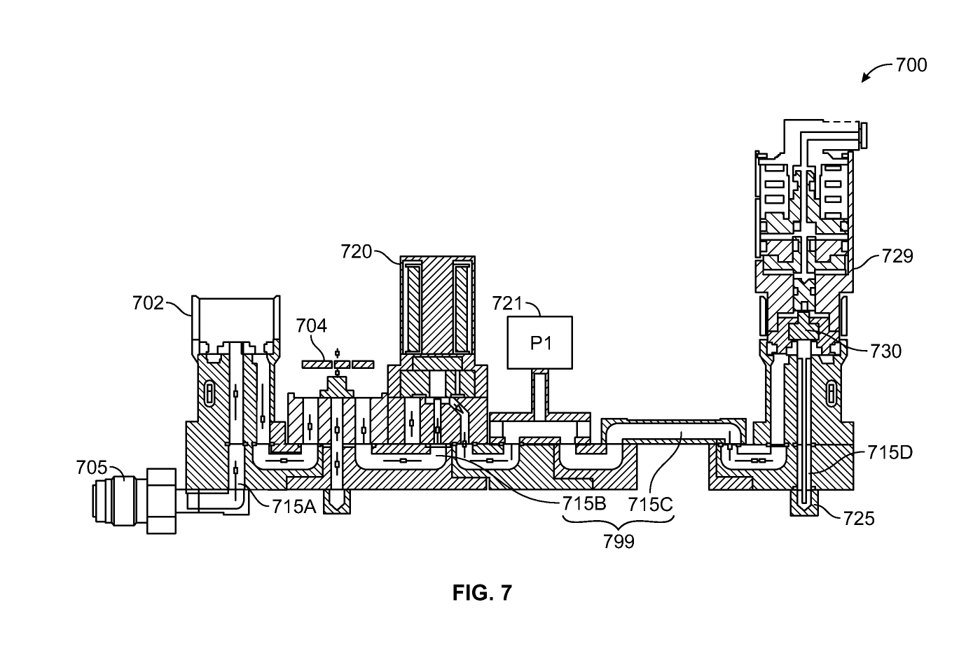

FIG. 7 is a perspective diagram illustrating a gas delivery apparatus 700 utilizing a reverse flow mode for fast bleed down of an accumulation volume 799, according to yet another embodiment. The gas delivery apparatus 700 may be used to provide controlled delivery of a reactant to a semiconductor manufacturing process, for example. The illustrated another gas delivery apparatus 700 includes a gas supply shut-off valve 702, an upstream cycle purge valve 704, a control valve 720, a pressure transducer 721, and a flow node 729. A flow path of the alternative gas delivery apparatus 700 includes a conduit inlet 705 receiving downstream to conduits 715A-D, accordingly, and exhausting downstream to a process at a conduit outlet 725. A preferred embodiment of the gas delivery apparatus 700 involves low flow gas delivery which can be characterized as less than 100 SCCM (standard cubic centimeters per minute) or approximately 4/1000 chemical mole per minute. Some alternative embodiments comprise more than one flow node for wider dynamic accuracy (e.g., in a parallel configuration).

An accumulated (accumulation) volume 799 includes at least a portion of space within the conduit 715B between the gas supply shut-off valve 702 and the control valve 720 combined with at least a portion of space within the conduit 715C between the pressure transducer 721 and a flow node 729. Spacing within and between components may also be included in consideration of the accumulated volume 799. The flow node 729 includes a characterized restrictor 730 in series and directly adjacent with a valve seat and diaphragm which together may function as a downstream outlet shut-off valve. The illustrated gas delivery apparatus 700 has a form factor comprising decentralized components making up a gas stick using a flow node and associated valves, sensors and control system, as opposed to the conventional gas stick of FIG. 1. The alternative gas delivery apparatus 700 illustrates use of metallic tubing and machined surface mount fluid delivery substrates as known in the semiconductor capital equipment industry.

A process control system (not shown) may use the gas delivery apparatus 700 in a forward flow mode in the following manner. Process gas enters through the inlet conduit 705 and passes through the gas supply valve 702 into the conduit 715B upstream of the control valve 720 while the upstream cycle purge valve 704 is in a closed condition. A target pressure set point may be calculated by the process control system based at least in part upon a desired mass flow rate to be provided to the process by the flow node 729. Signals from the pressure transducer 721, which measures a pressure within the conduit 715C upstream of the flow node 729, are used by the process control system to determine adjustments to the proportional valve 720 intended to keep the measured pressure approximately equal to the target pressure (opening the proportional valve 720 more if the measured pressure is too low or reducing the opening of the proportional valve 720 if the pressure is too high, as is known with forward pressure regulator control systems). Process gas flows from the conduit 715C upstream of the flow node 729, into the flow node 729, and through the characterized restrictor 730 and exhausting downstream to a process at a conduit outlet 725.

The process control system (not shown) may in the following manner use the gas delivery apparatus 700 in a reverse flow mode in response to inputs. Changing to reverse flow mode may be done when needing a fast reduction of gas delivery flow rate, for example. The gas supply valve 702 is placed into a closed condition and the upstream cycle purge valve 704 is placed into an open condition thereby connecting the conduit 715B upstream of the control valve 720 to a vacuum suction (sink) thereby reversing the flow supplied to the control valve 720 and rapidly reducing the supplied process gas pressure. Strategies for removing process gas from the conduit 715C between the control valve 720 and the flow node 729 may depend upon the inputs which led to use of the reverse flow mode. For example, the process control system may maximally open the proportional valve 720 thereby allowing process gas to very rapidly reverse flow leaving the conduit 715C and pass into the vacuum suction (sink) through the cycle purge valve 704. Alternatively, the process control system may calculate a new reduced target pressure set point and adjust the proportional valve 720 to keep the measured pressure approximately equal to the new reduced target pressure (reducing the opening of the proportional valve 720 if the measured pressure is too low or increasing the opening of the proportional valve 720 if the pressure is too high, as is known with back pressure regulator control systems).

### III. GENERALITIES OF THE DISCLOSURE

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. For example, it is contemplated that an apparatus operating in both a forward mode and a reverse mode can be used in environments other than MFCs of semiconductor manufacturing. The scope of the invention is defined by the following claims.

We claim:

1. An electronic regulator utilizing reverse flow for fast bleed down of gas pressure in a gas delivery apparatus supplying a process gas at specific mass flow rates to a process, the electronic regulator comprising:
a communication interface to receive a set point that defines a desired flow rate for delivery of the process gas to the process; and
a proportional valve controller, responsive to the set point, to determine whether to operate in a forward mode or a reverse mode for meeting a target pressure in an accumulated volume causing the flow rate, wherein in forward mode the process gas flows downstream through the proportional valve into the accumulated volume and in reverse mode the process gas flows upstream through the proportional valve out of the accumulated volume,
wherein the proportional valve is located within a conduit upstream of the accumulated volume and downstream from both a gas supply line that supplies the process gas and a purge line that evacuates process gas.

2. The electronic regulator of claim 1, wherein the proportional valve controller, in the forward mode, further opens the proportional valve to allow the process gas to flow downstream into the accumulated volume for increasing the gas pressure in the accumulated volume.

3. The electronic regulator of claim 1, wherein the proportional valve controller, in the reverse mode, further opens the proportional valve to allow the process gas to flow upstream out of the accumulated volume for decreasing the gas pressure in the accumulated volume.

4. The electronic regulator of claim 1, wherein the proportional valve, responsive to the proportional valve controller, switches from forward mode to reverse mode for fast bleed down of the gas pressure from the accumulated volume.

5. The electronic regulator of claim 1, wherein, responsive to being in reverse mode, the purge valve opens for upstream evacuation of the process gas from the accumulated volume.

6. The electronic regulator of claim 1, wherein, responsive to being in reverse mode, the gas supply line closes for stopping additional flow of the process gas into the accumulated volume.

7. The electronic regulator of claim 1, wherein the proportional valve has a specific flow resistance that retains the process gas in the accumulated volume.

8. The electronic regulator of claim 1, further comprising:
a processor, coupled in communication with the communication interface and the proportional valve controller, to convert set points received by the communication interface to time-based set points that affect the proportional valve.

9. The electronic regulator of claim 1, further comprising:
a sensor interface, coupled to the proportional valve controller, to receive pressure readings associated with the accumulated volume.

10. The electronic regulator of claim 1, wherein the electronic regulator is part of an MFC (mass flow controller).

11. The electronic regulator of claim 1, wherein the accumulated volume comprises an aggregate of volumes including conduit space and spacing among components.

12. The electronic regulator of claim 1, wherein the accumulated volume is effectively separated from additional downstream portions of the gas delivery apparatus by a characterized restrictor located downstream of the accumulated volume.
